(19) United States
(12) Patent Application Publication
(10) Pub. No.: US 2026/0094998 A1
(43) Pub. Date: Apr. 2, 2026

(54) CONNECTOR STRUCTURE FOR IMPROVING CROSSTALK

(71) Applicant: VSO ELECTRONICS CO., LTD. (R.O.C.), New Taipei City (TW)

(72) Inventors: CHUNG CHENG CHIEN, New Taipei City (TW); WEI CHUN LIAO, New Taipei City (TW); YU CHEN PAN, New Taipei City (TW)

(21) Appl. No.: 19/082,296

(22) Filed: Mar. 18, 2025

(30) Foreign Application Priority Data
Sep. 27, 2024 (TW) TW113137027

(51) Int. Cl. H01R 13/6471

(52) U.S. Cl. CPC H01R 13/6471

(57) ABSTRACT

A connector structure for improving crosstalk is disclosed. The connector structure has a base, a first ground connecting sheet, and a second ground connecting sheet. The base includes a first terminal group and a second terminal group. The first ground connecting sheet is disposed within the base and connected to first ground terminals of the first terminal group. The second ground connecting sheet is disposed within the base and connected to second ground terminals of the second terminal group. A gap is disposed between the first ground connecting sheet and the second ground connecting sheet so as to prevent them from conducting with each other. Thus, the first terminal group and the first ground connecting sheet form an independent conducting route while the second terminal group and the second ground connecting sheet form another independent conducting route. Consequently, the overall impedance path of the connector structure can be reduced such that signal decay and crosstalk could be effectively improved during high frequency transmissions.

### BACKGROUND OF THE INVENTION

### Field of the Invention

The present invention relates to a connector structure for improving crosstalk, and more particularly to a connector structure for improving signal decay and crosstalk during high frequency transmissions.

### Description of the Related Art

Please refer to FIG. 1 and FIG. 2 which are schematic diagrams of a conventional connector. The connector A comprises an upper tongue plate A1 and a lower tongue plate A2. An upper terminal group B is located on the upper tongue plate A1 and a lower terminal group C is located on the lower tongue plate A2. The upper terminal group B comprises a plurality of upper ground terminals B1 and the lower terminal group C comprises a plurality of lower ground terminals C1. The connector A comprises a ground sheet D which includes a plurality of upper ground pins D1 connected to the upper ground terminals B1 of the upper terminal group B and a plurality of lower ground pins D2 connected to the lower ground terminals C1 of the lower terminal group C. Thus, the plurality of upper ground terminals B1 are electrically connected to the plurality of lower ground terminals B2.

While the conventional connector A utilizes the ground sheet D to form a conducting route between the upper ground terminals B1 of the upper terminal group B and the lower ground terminals C1 of the lower terminal group C, it causes a higher overall impedance path of the connector A, leading to an increased signal decay during high frequency transmissions.

Therefore, an object of the invention is to provide a connector structure for improving signal decay and crosstalk during high frequency transmission.

### BRIEF SUMMARY OF THE INVENTION

According to an embodiment of the present invention, a connector structure for improving crosstalk has a base, a first ground connecting sheet, and a second ground connecting sheet.

The base includes a first terminal group and a second terminal group which are disposed on a front end of the base and extended outward from the front end. The first terminal group and the second terminal group correspond to each other and there is a first gap between the first terminal group and the second terminal group. The first terminal group has at least two first ground terminals and the second terminal group has at least two second ground terminals. The first ground connecting sheet is disposed within the base and adjacent to the first terminal group. The first ground connecting sheet has at least two first connecting terminals which are electrically connected to the first ground terminals of the first terminal group respectively, either through direct contact or being connected through a conductor. The second ground connecting sheet is disposed within the base and adjacent to the second terminal group. The second ground connecting sheet has at least two second connecting terminals which are electrically connected to the second ground terminals of the second terminal group respectively, either through direct contact or being connected through another conductor.

There is a second gap between the first ground connecting sheet and the second ground connecting sheet so as to prevent them from conducting with each other. Thus, the first terminal group and the first ground connecting sheet form an independent conducting route while the second terminal group and the second ground connecting sheet form another independent conducting route. In addition, an electrical insulator is filled into the second gap so as to prevent the first ground connecting sheet from electrically connecting to the second ground connecting sheet.

Accordingly, the connector structure of the present invention utilizes the second gap to prevent the first ground connecting sheet from electrically connecting the second ground connecting sheet. In other words, the first terminal group and the first ground connecting sheet form an independent conducting route while the second terminal group and the second ground connecting sheet form another independent conducting route. Consequently, the overall impedance path of the connector structure can be reduced such that signal decay and crosstalk could be effectively improved during high frequency transmissions.

### BRIEF DESCRIPTION OF THE DRAWINGS

Embodiments of the invention can be more fully understood by reading the subsequent detailed description and examples with references made to the accompanying drawings, wherein:

FIG. 1 is a stereo diagram of a conventional connector according to the prior art;

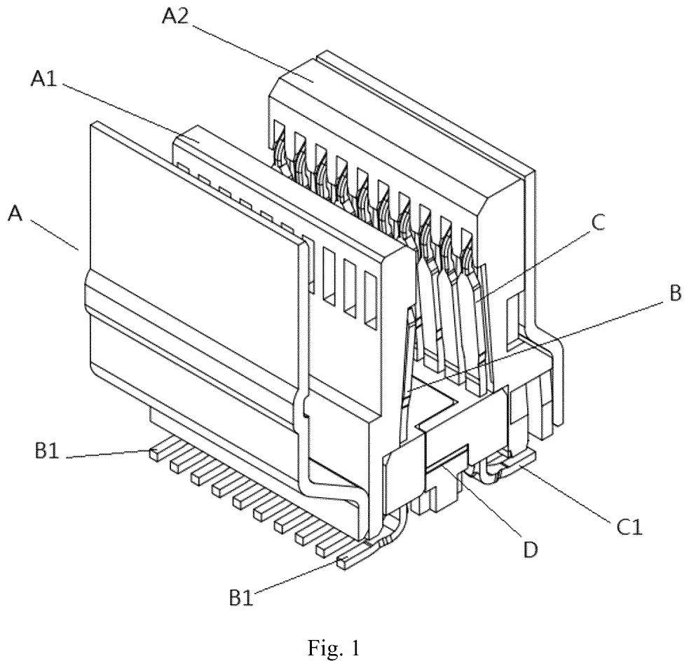

FIG. 2 is a schematic exploded view of the conventional connector according to the prior art;

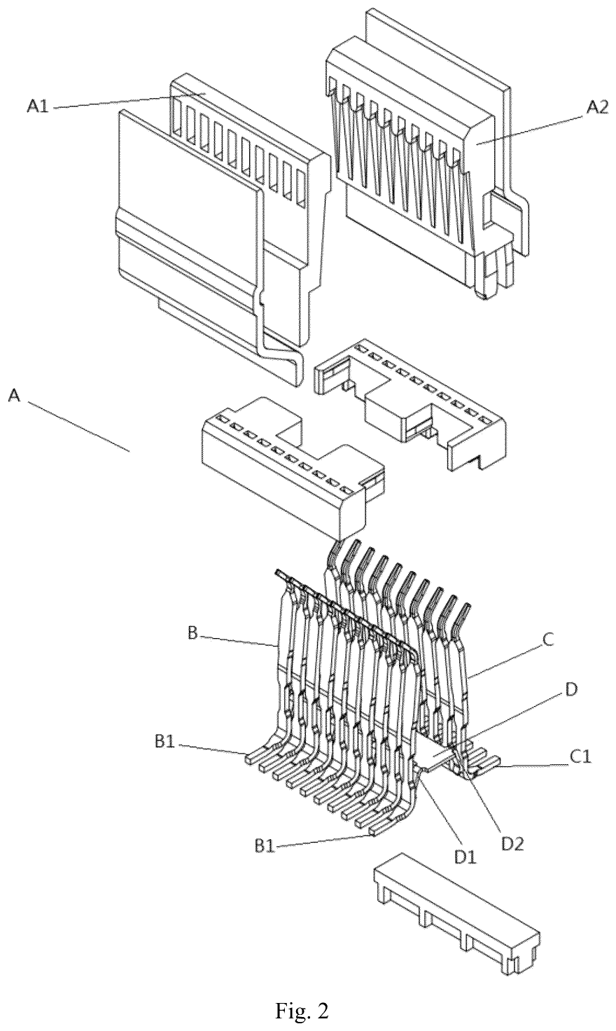

FIG. 3 is a stereo diagram of a connector structure for improving crosstalk according to an embodiment of the present invention;

FIG. 4 is a schematic exploded view of the connector structure for improving crosstalk according to an embodiment of the present invention;

FIG. 5 is a schematic cross-sectional view of the connector structure for improving crosstalk according to an embodiment of the present invention; and

FIG. 6 is a schematic diagram of S-parameters testing results of the conventional connector and the connector structure according to an embodiment of the present invention.

### DETAILED DESCRIPTION OF THE INVENTION

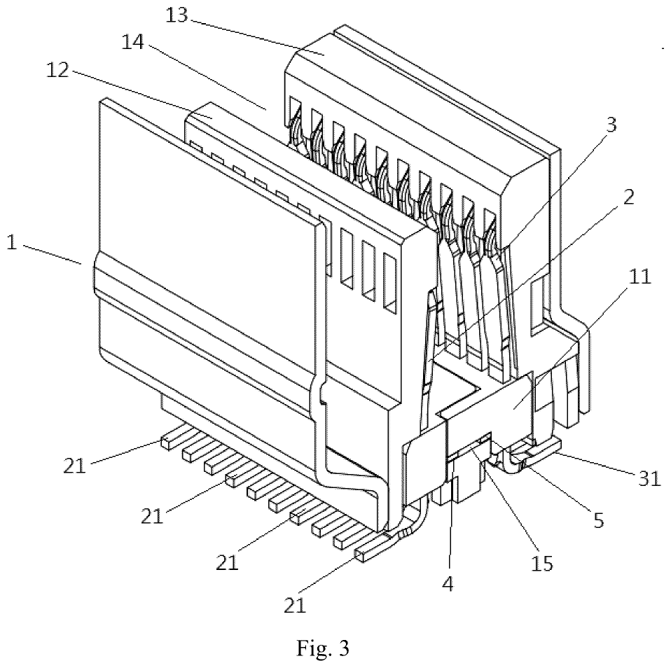

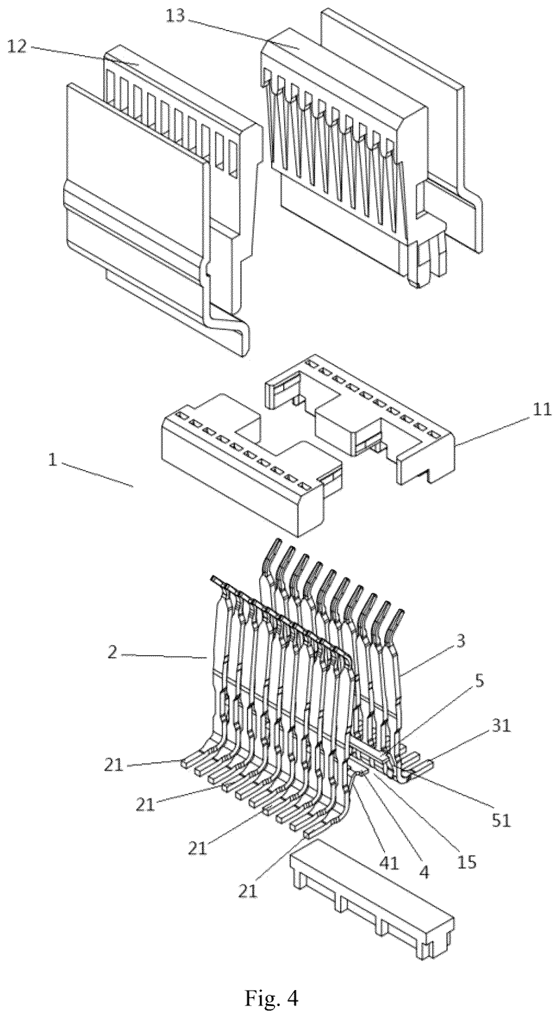

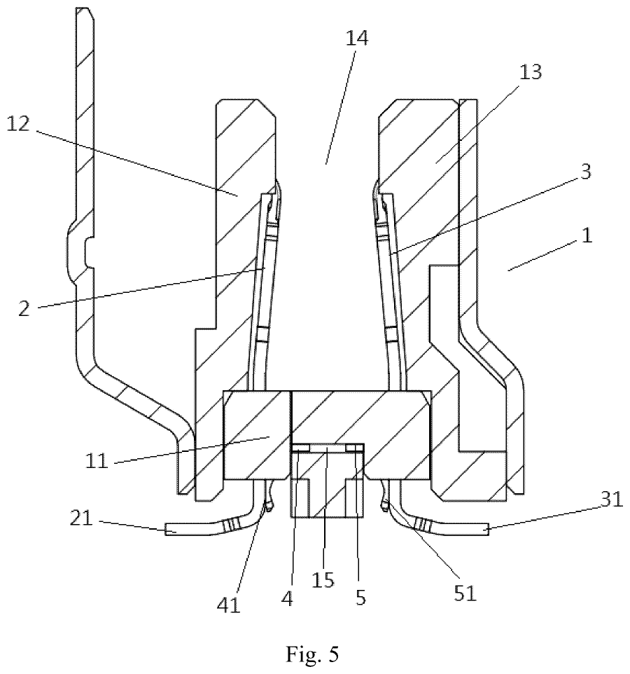

Please refer to FIGS. 3 to 5. The present invention discloses a connector structure for improving crosstalk. The connector structure 1 comprises a base 11, a first ground connecting sheet 4, and a second ground connecting sheet 5.

According to an embodiment of the invention, the base 11 further comprises a first tongue plate 12 and a second tongue plate 13 extended from a front end of the base. The first tongue plate 12 and the second tongue plate 13 correspond to each other while one of them is located in the upper portion of the front end of the base and the other is located in the lower portion of the front end of the base. The base 11 further comprises a first terminal group 2 disposed on an inner side of the first tongue plate 12 and a second terminal group 3 disposed on an inner side of the second tongue plate 13. The first terminal group 2 and the second terminal group 3 are also extended from the front end of the base. The first terminal group 2 and the second terminal group 3 correspond to each other and face each other. There is a first gap 14 between the first terminal group 2 and the second terminal group 3. The first terminal group 2 comprises at least two ground terminals 21. The second terminal group 3 comprises at least two ground terminals 31. In an embodiment, the first terminal group 2 comprises four ground terminals 21 and the second terminal group 3 also comprises four ground terminals 31.

The first ground connecting sheet 4 is disposed within the base 11 and adjacent to the first terminal group 2. The first ground connecting sheet 4 comprises at least two first connecting terminals 41 extended outward from the base 11. The first connecting terminals 41 are electrically connected with the first ground terminal 21, either through a direct contact or connected through a conductor. In an embodiment, the first ground connecting sheet 4 comprises four first connecting terminals 41 extended toward the back end of the base 11. The four first connecting terminals 41 are electrically connected with the four first ground terminals 21 respectively.

The second ground connecting sheet 5 is disposed within the base 11 and adjacent to the second terminal group 3. The second ground connecting sheet 5 comprises at least two second connecting terminals 51 extended outward from the base 11. The second connecting terminals 51 are electrically connected with the second ground terminal 31, either through a direct contact or connected through another conductor. In an embodiment, the second ground connecting sheet 5 comprises four second connecting terminals 51 extended toward the back end of the base 11. The four second connecting terminals 51 are electrically connected with the four second ground terminals 31 respectively.

There is a second gap 15 between the first ground connecting sheet 4 and the second ground connecting sheet 5 so as to prevent them from being electrically connected. In an embodiment, an electrical insulator is filled into the gap 15. Thus, the first terminal group 2 and the first ground connecting sheet 4 form an independent conducting route while the second terminal group 3 and the second ground connecting sheet 5 form another independent conducting route. The first ground connecting sheet 4 and the second ground connecting sheet 5 correspond to each other and are arranged in parallel within the base 11.

As mentioned above, since two independent conducting routes are formed in the connector structure 1 according to the present invention, the overall impedance path of the connector structure 1 can be reduced, leading to improve the signal decay and crosstalk during high frequency transmission.

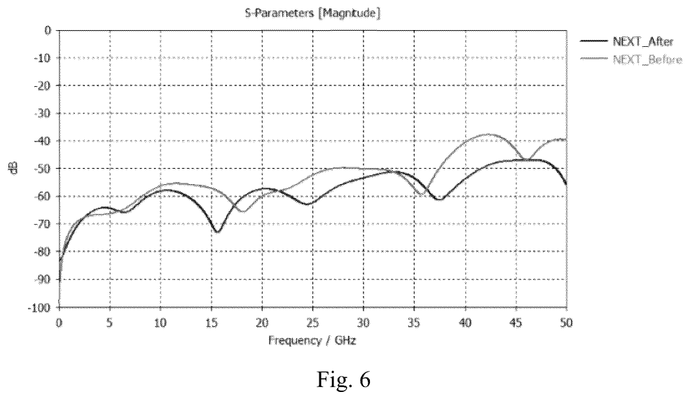

Please refer to FIG. 6, which is a schematic diagram of S-parameters testing results of the conventional connector and the connector structure according to an embodiment of the present invention. As shown in FIG. 6, the horizontal axis represents the frequencies and the vertical axis represents the dB values. Based on the S-parameter testing result, the connector structure according to the present invention has a decay less than −40 dB for the interval between 35 GHz to 45 GHz. On the contrary, under the same high frequency test, the conventional connector has a decay beyond −40 dB and even close to −50 dB. In comparison with the conventional connector, the connector structure of the present invention has a better performance in the signal decay for the high frequency region (higher than 35 GHz). As a result, the present invention does improve the signal decay situation during the high frequency transmissions. Also, in the current high speed connector era, it meets the requirements of PAM4 and PCIe 5.0.

The aforementioned description merely represents a preferred embodiment of the invention and should not be used to limit the scope of the claimed invention. Any simple equivalent changes or modifications made based on the claims and specification of the invention shall still fall within the scope covered by the invention. Furthermore, any embodiment or claims of this invention is not necessary to achieve all the disclosed purposes, advantages, or features. Additionally, the abstract and title are provided solely to assist in patent document searches and are not intended to limit the scope of the invention. Moreover, the terms “first”, “second”, “third”, “fourth”, and so forth, mentioned in the specification or claims, are merely used to name components or distinguish different embodiments or scopes, and do not imply any upper or lower limitations on the component quantities.

What is claimed is:

1. A connector structure for improving crosstalk, the connector structure comprising:
a base further comprising a first terminal group and a second terminal group extended from a front end of the base, the first terminal group and the second terminal group corresponding to each other, a first gap being formed between the first terminal group and the second terminal group, the first terminal group comprising at least two first ground terminals and the second terminal group comprising at least two second ground terminals;
a first ground connecting sheet disposed within the base and adjacent to the first terminal group, the first ground connecting sheet comprising at least two first connecting terminals, the first connecting terminals being electrically connected to the first ground terminals, either through a direct contact or through a conductor; and
a second ground connecting sheet disposed within the base and adjacent to the second terminal group, the second ground connecting sheet comprising at least two second connecting terminals, the second connecting terminals being electrically connected to the second ground terminals, either through a direct contact or through another conductor;
wherein there is a second gap between the first ground connecting sheet and the second ground connecting sheet so as to prevent the first ground connecting sheet from being electrically connected to the second ground connecting sheet, the first terminal group and the first ground connecting sheet form an independent conducting route, and the second terminal group and the second ground connecting sheet form another independent conducting route.

2. The connector structure according to claim 1, wherein the base further comprises a first tongue plate extended from an upper portion of the front end of the base and a second tongue plate extended from a lower portion of the front end of the base, and wherein the first terminal group is disposed on an inner side of the first tongue plate, the second terminal group is disposed on an inner side of the second tongue plate, and the first terminal group and the second terminal group corresponds to each other.

3. The connector structure according to claim 1, wherein the first terminal group comprises a plurality of first ground terminals, the first ground connecting sheet extends toward a back end of the base and comprises a plurality of first connecting terminals, and the first connecting terminals adjoin the first ground terminals respectively.

4. The connector structure according to claim 1, wherein the second terminal group comprises a plurality of second ground terminals, the second ground connecting sheet extends toward a back end of the base and comprises a plurality of second connecting terminals, and the second connecting terminals adjoin the second ground terminals respectively.

5. The connector structure according to claim 1, wherein the first ground connecting sheet and the second ground connecting sheet are arranged in parallel within the base.

6. The connector structure according to claim 1, wherein an electrical insulator is filled into the second gap so as to prevent the first ground connecting sheet from electrically connecting to the second ground connecting sheet.
